(19) United States
(12) Patent Application Publication
(10) Pub. No.: US 2003/0171916 A1
(43) Pub. Date: Sep. 11, 2003

(54) Audio signal reproducing method and an apparatus for reproducing the same

(75) Inventor: Susumu Kamba, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/379,700

(22) Filed: Mar. 6, 2003

(30) Foreign Application Priority Data
Mar. 6, 2002 (JP) 2002-059739

(51) Int. Cl. G10L 19/14

(52) U.S. Cl. 704/205

(57) ABSTRACT

A method of reproducing audio signals comprises: transforming audio signals into a plurality of frequency components; seeking the plurality of the frequency components for a reference frequency component domain; attenuating power of at least one of reference components in the reference frequency component domain to interpolate the frequency component in a frequency band higher than the reference frequency component domain, and transforming the interpolated frequency component into a time component. And an apparatus of reproducing audio signals comprising: a frequency component decoder configured to decode audio signals into frequency components; a frequency component domain seeking unit configured to seek the frequency components for a reference frequency component domain that is to be interpolated in a high frequency band; a reference frequency component extractor configured to extract a reference frequency component from the reference frequency component domain; a frequency component power transforming unit configured to attenuate power of the reference frequency component for producing a frequency component that is to be interpolated, and an inverter configured to transform the interpolated frequency component into a time component.

### CROSS REFERENCE TO RELATED APPLICATION

This application is based upon and claims the benefit of priority from the prior Japanese Patent Applications No. 2002-059739, filed on Mar. 6, 2002; the entire contents of which are incorporated herein by reference.

### BACKGROUND OF THE INVENTION

The present invention relates to a method of reproducing compressed audio signals and an apparatus for reproducing the audio signals.

In general, an encoder employed in a technology of compressed recording of audio signals, etc. functions to quantize frequency components by unit of bit allocation where quantifying bit numbers are determined depending upon the frequency components. In bit allocation, a restriction is imposed on the total amount of bits permitted for encoding the frequency components due to an encoding bit rate, and hence, it is required to allocate bits appropriately to avoid acoustic degradation under such a restriction. A determination of the amount of bits through the bit allocation also relies upon powers of the frequency components and the total of the powers of them within sub-bands divided with a certain bandwidth so as to accommodate the resultant sound to a human sense of hearing.

For example, the followings are common procedures of such bit allocation attained in MPEG-1 and MPEG-2 audios, respectively. Allowing for distributions (forms) of the frequency components and thresholds or audible levels of the human sense of hearing the frequency components, a masking level is computed for each sub-band. Then, a procedure of sequentially adding bits to sub-bands is started from the one having the smaller rate of the computed masking level to a quantized noise till the total number of the quantized bits reaches the maximum allocatable value.

FIG. 6 is a block diagram of a prior art decoder, illustrating a basic structure of the decoder that is used in audio sound compressing technology relying on the coding. Audio signals (a stream of audio signals), which are transmitted from the encoder, are received at an input terminal and are decoded into frequency components by a frequency component decoder 1. Generally, the frequency components are sectioned into segments of certain bandwidths, and each segment is normalized by a value called scale factor in each sub-band. Quantizing the normalized value is a method that has been widely used. The frequency component decoder 1 produces the frequency component that is obtained by inversely quantizing the normalized value and then multiplying it by the scale factor. The resultant frequency component is applied to an inverter 2 to have it inverted, and thus, a decoded audio signal is produced.

In the bit allocation in the decoder, basically a frequency component or a sub-band of greater power has a correspondingly larger amount of bits allocated. Thus, as to a general audio signal, middle to low frequency bands having power concentrated tend to get larger amount of bit allocation.

On the other hand, high frequency bands generally have reduced power, and are less audible due to a nature of the human sense of hearing; and hence are, are allocated bits are smaller than those to the mid to low frequency bands. However, this would not prove that a reproduction of the high frequency bands is useless.

If the encoding bit rate is reduced, it leads to a decrease in the total number of allocated bits. As a consequence, a privileged allocation of greater bits to the mid to low bands is unavoidable because of contribution of those bands to the quality, but instead, the high bands originally having smaller bits allocated should further decrease the number of bits allocated.

The encoding bit rate sometimes may cause the allocated bits to the high sub-bands or the high frequency components to be naught. This unit a production of a frequency component that keeps unencoded or undecoded. Keeping the high frequency bands unencoded or undecoded leads to an equivalent effect to a band limitation, which causes a further deterioration of acoustics to the human auditory sense. Thus, it should be noted that the bit allocation to the high bands is necessary even if the number of bits is relatively smaller than those allocated to the mid to low bands.

When the encoding bit rate is low, however, the bit allocation to the entire targeted frequency band results in the high bands having relatively increased bits allocated relative to the mid to low bands. This unit an unavoidable decrease in allocated bits to the mid to low bands that make a greater contribution to the quality, which eventually leads to a degradation of a decoded audio signal and deterioration of the reproduced signals.

### SUMMARY OF THE INVENTION

According to one embodiment of the present invention, there is provided a method of reproducing audio signals comprises: transforming audio signals into a plurality of frequency components; seeking the plurality of the frequency components for a reference frequency component domain; attenuating power of at least one of reference components in the reference frequency component domain to interpolate the frequency component in a frequency band higher than the reference frequency component domain, and transforming the interpolated frequency component into a time component.

According to another embodiment of the present invention, there is provided an apparatus of reproducing audio signals comprising: a frequency component decoder configured to decode audio signals into frequency components; a frequency component domain seeking unit configured to seek the frequency components for a reference frequency component domain that is to be interpolated in a high frequency band; a reference frequency component extractor configured to extract a reference frequency component from the reference frequency component domain; a frequency component power transforming unit configured to attenuate power of the reference frequency component for producing a frequency component that is to be interpolated, and an inverter configured to transform the interpolated frequency component into a time component.

### BRIEF DESCRIPTION OF THE DRAWINGS

FIG. 1 is a flow chart of an audio reproducing method or a first embodiment of the present invention;

FIG. 2 is a graph illustrating a distribution of frequency components in the first embodiment;

FIG. 3 is a block diagram of an audio reproducing apparatus or a second embodiment of the present invention;

FIG. 4 is a block diagram of the audio reproducing apparatus or a third embodiment of the present invention;

FIG. 5 is a block diagram of the audio reproducing apparatus or a fourth embodiment of the present invention; and

FIG. 6 is a block diagram of the prior art audio reproducing apparatus.

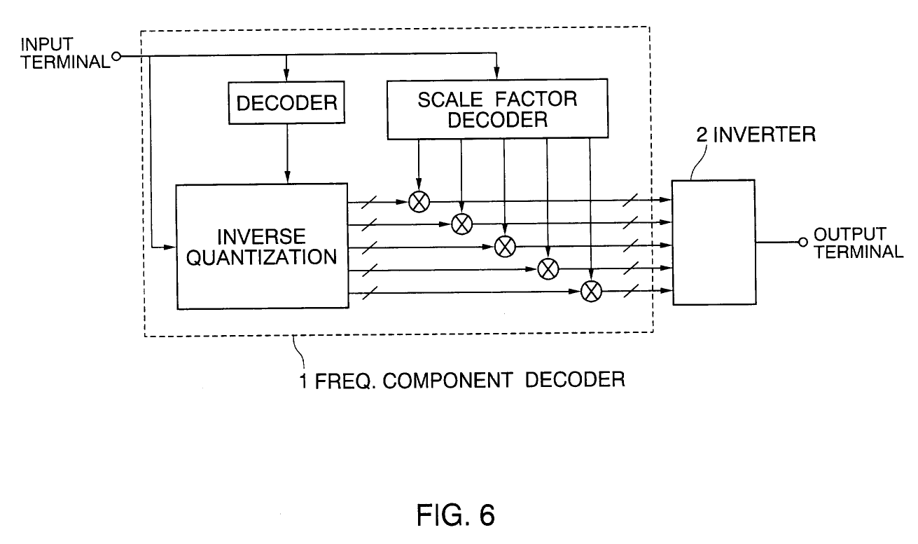

### DETAILED DESCRIPTION OF THE INVENTION

Embodiments of the present invention will now be described in detail in conjunction with the accompanying drawings. For convenience of understanding characteristics of the subject matter of the present invention, it is presumed that input audio signals (an input stream of audio signals) carry no frequency components higher than a certain frequency.

<Embodiment 1>

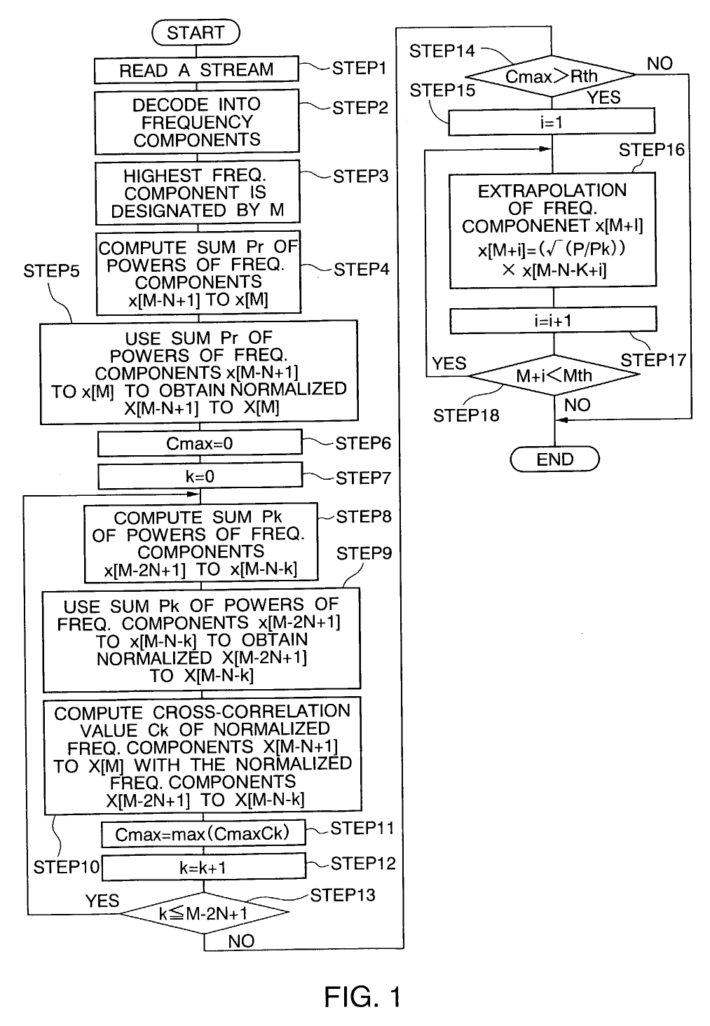

An embodiment of an audio reproducing method will be detailed. FIG. 1 is a flow chart of the exemplary audio reproducing method.

Encoded compressed audio signals (a stream of such signals) are received (Step 1). The input audio signals are decoded into frequency components (Step 2). A method of the decoding at Step 2 is usually a reverse transformation which corresponds to the kind of encoding but not limited to a specific way.

Then, among the decoded audio signals, the one having the highest frequency component is sought to designate its frequency component as x[M] (M is an integer) (Step 3). It is assumed that the frequency components are incrementally numbered, starting with x[0] for the lowest. Then, N(N is an integer and M>N) frequency components x[M−N+1] to x[M] are extracted in a decrementing series starting with x[M] and they are all added to compute a sum Pr (Step 4). Then, the sum Pr is used to normalize the frequency components x[M−N+1] to x[M] (Step 5). The normalized frequency component x[M−N+1] to x[M] are denoted by X[M−N+1] to X[M].

After that, Cmax that keeps the maximum cross-correlation value is initialized to Cmax=0 (Step 6). Also, k (k is an integer) is set to zero, k=0 (Step 7).

At succeeding Step 8 to Step 10, a sequence of N frequency components are extracted without including any of the N frequency components x[M−N+1] to x[M] sought at Step 4 to compute a cross-correlation value C to a power series of the normalized frequency components X[M−N+1] to X[M].

First, at Step 8, selected are the N frequency components in a decrementing series starting with x[M−N−k], namely, x[M−2N+1−k] to x[M−N−k], which are all added to compute a sum Pk. The sum Pk is used to normalize the frequency components x[M−2N+1−k] to x[M−N−k] (Step 9). The normalized frequency components are designated by X[M−2N+1] to X[M−N].

Next, computed is a cross-correlation value Ck of a power series of the normalized frequency components X[M−2N+1−k] to X[M−N−k] to the power series of the normalized frequency components X[M−N+1] to X[M] (Step 10).

Then, the maximum cross-correlation value Cmax is compared with the cross-correlation value Ck. Inconsequence of the comparison, the value of Ck, if larger, is saved to update Cmax (Step 11).

k is incremented and k=k+1 (Step 12). After that, it is determined if k is greater than M−2N+1 by unit of comparison (Step 13). If the result shows k equal to or below N−2N+1, a procedure of Step 8 is repeated. Thus for all the ranges of the frequency components, Step 8 to Step 11 are repetitively carried out. On the other hand, if it is determined that k is larger than M−2N+1, or if all the ranges of the frequency components have been searched, an instruction at Step 14 is then executed.

Now, it is assumed that a cross-correlation value with a given value of K (K is an integer) is maximized (CK=Cmax). In this situation, the frequency components x[M−N+1−K] to x[M] are defined as a reference domain of the frequency components that are to be interpolated in the high frequency band.

When it is determined, as a consequence of the comparison at Step 13, that k is greater than M−2N+1, if Cmax is no more than the threshold value Rth (Step 14), the following extrapolation would not be performed. Such operation will be explained later as the fourth embodiment.

If Cmax exceeds Rth, the extrapolation will be performed and i is set to a relation i=l (i is an integer) (Step 15). Then, \sqrt{Pr/PK}×x[M−N−K+i] is computed to obtain the resultant frequency component x[M+i] (Step 16). PK is the total of the frequency components x[M−2N+1−K] to x[M−N−K]. At Step 16, the reference frequency component undergoes a certain attenuation to obtain frequency components that are to be interpolated.

Then, i is incremented and i=i+1 (Step 17). After that, M+i and Mth are compared (Step 18). Mth is the maximum number of the frequencies required for signal reproduction, which is smaller than a transformation order used to prevent a turnaround distortion. As a result of the comparison, when the M+i is smaller than Mth, an instruction at Step 16 is executed to interpolate additional frequency components. On the contrary, when M+i is equal to or higher than Mth, the extrapolation is completed. Since an extrapolation of data greater than Mth is prone to develop the turnaround distortion, any other extrapolation is not performed.

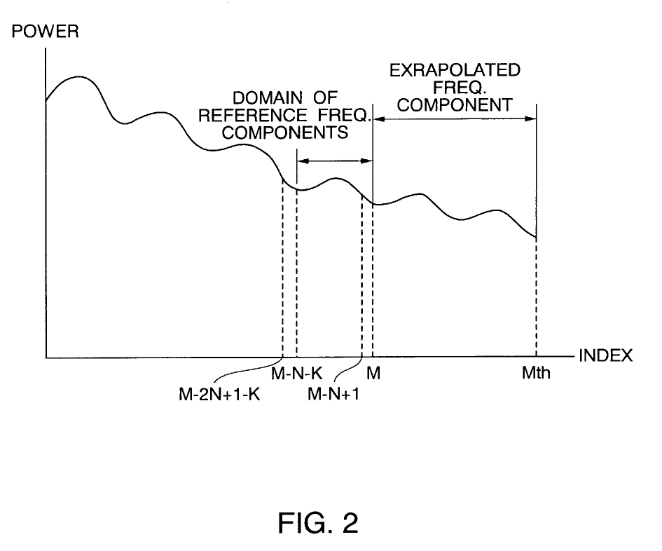

FIG. 2 is a graph illustrating a distribution of the frequency components when the exemplary steps according to this embodiment are executed.

In accordance with this embodiment of the present invention, as has been described, even with an audio signal that is encoded at low encoding bit rate that often causes difficulty in encoding high frequency components in an encoder, generation or extrapolation of the high frequency components in a decoder enables the audio signal to be decoded or reproduced with desired information amount. In this way, an acoustic degradation of the reproduced signal for the human sense of hearing can be reduced.

Also, allowing for steps of producing and interpolating the high frequency components in the decoder as in the embodiment of the present invention, bit allocation becomes possible, concentrated on middle to low frequency bands that contribute to the quality.

In the flowchart in FIG. 1, Steps 8 to 11 are repetitively executed for all the frequency components, but alternatively, it is also possible that, for an additionally determined threshold value Cr relative to the cross-correlation value, the seek procedures at Steps 8 to 11 are interrupted if the computed cross-correlation value Ck is above the threshold value Cr, and instead, Step 16 is executed. In such a situation, a level (K) at which the cross-correlation value just exceeds the threshold value Cr turns to be a criterion, and the frequency components x[M−N+1−K] to x[M] become a reference domain of the frequency components that are to be interpolated. The determination of the threshold value Cr brings about a reduction of the number of repetitions of the seek procedures (Step 8 to Step 12).

Although, at Step 16, the attenuation is carried out by a multiplication of the reference frequency components by \sqrt{P/PK}, a certain value such as −6 dB/oct should be used for the attenuation if the rate Pr/PK is greater than 1. Alternative to computing such a rate, at Step 16, a certain attenuation factor may be applied to all.

<Embodiment 2>

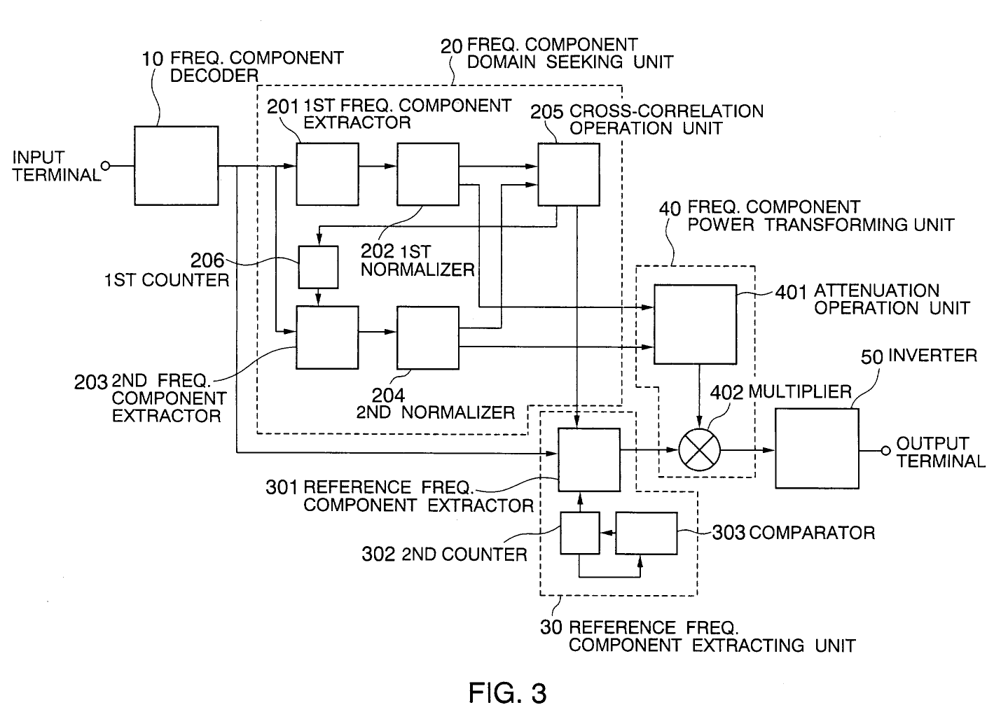

FIG. 3 is a block diagram showing an audio signal reproducing device or a second embodiment according to the present invention, developed to implement the reproducing method as described above. The audio signal reproducing device is comprised of a frequency component decoder 10 which decodes a coded audio signal into frequency components, a frequency component domain seeking unit 20 which seeks for a domain of reference frequency component that is used as reference for extrapolation, a reference frequency component extracting unit 30 which extracts the reference frequency component from the retrieved reference frequency component domain, a frequency component power transforming unit 40 which transforms the reference frequency component to a desired level (of power), and an inverter 50 which converts the audio signal from the frequency components to time components where the audio signals (a stream of audio signals) are received at an input terminal to the frequency component decoder 10.

The frequency component domain seeking unit 20 seeks frequency component domains at a certain level from the high frequency band of the maximum frequency component for a different frequency component domain of the maximum cross-correlation value. This brings about a determination of the reference frequency component domain that is to be interpolated in the high frequency band that does not exist in the stream.

Specifically, the frequency component domain seeking unit 20 has a first frequency component extractor 201 extracting N (integer) frequency components (a first frequency component domain) in a decrementing series starting with the highest frequency, a first frequency component normalizer 202 normalizing the frequency components extracted by the first frequency component extractor 201, a second frequency component extractor 203 extracting N frequency components (a second frequency component domain) in series from a range different from the range that has undergone the extraction by the first frequency component extractor 201, a second frequency component normalizer 204 normalizing the frequency components extracted by the second frequency extractor 203, a cross-correlation operation unit 205 computing a cross-correlation value C of the frequency components extracted by the second frequency component extractor 203, and a first counter 206 producing the first coefficient k used to select domains that are to be extracted by the second frequency component extractor 203.

The reference frequency component extracting unit 30 extracts the reference frequency component. For instance, the reference frequency component extracting unit 30 has a reference frequency component extractor 301 to extract a reference frequency component that is to be a reference for extrapolation, a second counter 302 to produce a second coefficient i used to select the reference frequency component that is to be extracted, and a comparator 303 to compare a maximum extrapolation index Mth with an extrapolation index M+i.

The frequency component power transforming unit 40 serves to transform (attenuate) power of the reference frequency component. Specifically, the frequency component power transforming unit 40 has an attenuation factor operation unit 401 computing an attenuation factor, and a multiplier 402 multiplying the computed attenuation factor by the reference frequency component produced from the reference frequency extracting unit 30. For example, with the attenuation factor, produced is a computation result derived from the reference domain determined by the frequency component domain seeking unit 20.

Now, an operation of the audio signal reproducing device in FIG. 2 will be described. A stream of signals, when received at the input terminal, is decoded into frequency components x[0] to x[M] by the frequency component decoder 10 and then transmitted to the frequency component domain seeking unit 20. The frequency components x[0] to x[M] are supposed to be in an incrementing series starting with the frequency component of the lowest power.

The frequency components x[0] to x[M] transmitted to the frequency component domain seeking unit 20 undergo the extraction in the first frequency component extractor 201, consequently having N frequency components x[M−N+1] to x[M] extracted in series in a decrementing order starting with the frequency component x[M]. Then, the sum Pr of x[M−N+1] to x[M] extracted in the first frequency component extractor 201 is computed in the first frequency component normalizer 202. The sum Pr is used to normalize x[M−N+1] to x[M] (normalized results X[M−N+1] to X[M]).

In the second frequency contractor 203, a value k from the first counter 206 (the first coefficient) is used to extract a series of N frequency components x[M−2N+1−k] to x[M−N−k]. Then, the second frequency component normalizer 204 computes the sum Pk of x[M−2N+1−k] to x[M−N−k] extracted by the second frequency components 203. The sum Pk is used to normalize x[M−2N+1−k] to x[M−N−k] (normalized results X[M−2N+1−k] to X[M−N−k]).

In this way, the first and second frequency component normalizers 202 and 204 respectively produce the normalized frequency components X to the cross-correlation operation unit 205. The cross-correlation operation unit 205 computes a cross-correlation value Ck of a power series of the frequency components X[M−2N+1−k] to X[M−N+1−k] normalized in the second frequency component normalizer 203 to the power series of the frequency components X[M−N+1] to X[M] normalized in the first frequency component normalizer 201. The resultant cross-correlation value Ck is compared with the maximum cross-correlation value Cmax, and as a consequence, if the cross-correlation value Ck is larger, the maximum cross-correlation value Cmax is updated and saved as Ck. In this situation, k is saved as an updated value in K=k.

Assuming that a coefficient from the first counter 206 at the highest cross-correlation value C is designated by K (i.e., CK=Cmax), the attenuation factor operation unit 401 produces through an arithmetic operation a square root of a rate of the sum Pr of the frequency components x[M−N+1] to x[M] to the sum PK of the frequency components x[M−2N+1−K] to x[M−N+1−K] (i.e., \sqrt{Pr/PK}).

In the reference frequency component extracting unit 30, using the value K for the maximum cross-correlation value (CK=Cmax) and the value i on the second counter 302 (i is a second coefficient, and is an integer), the reference frequency component extractor 301 extracts a frequency component x[M−N−K+i].

After that, the multiplier 402 is used to obtain a product of the frequency component x[M−N−K+i] extracted in the reference frequency component extracting unit 30 multiplied by the value \sqrt{Pr/PK} resulted from the computation in the attenuation factor operation unit 401, and the resultant (M+i)th frequency component x[M+i] (=\sqrt{Pr/PK}×x[M−N−K+i]) is interpolated.

After the computation result or frequency component x[M+i] is transmitted to the inverter 50 and is transformed into a time component, namely it is decoded. In this manner, the audio signals are reproduced, covering the high frequency band that does not exist in the stream.

The reference frequency component extracting unit 30 monitors domains in which the frequency components are interpolated. The comparator 303 compares the maximum number of interpolated components Mth with a location of the extrapolation M+i. As a result of the comparison, if Mth is larger than M+i, the value at the second coutner 302 is incremented by 1, and thus, the reference frequency component extractor 301 extracts the reference frequency component represented by x[M−N−K+i]. On the contrary, if M+i is equal to or above Mth, the operation of the second counter 302 is interrupted, and hence, the reference frequency components extractor 301 no longer produces an additional reference frequency component. The frequency component x[M+i]produced by the multiplier 402 is transmitted to the reference frequency extracting unit 30, and it is used as the reference frequency component when the number of signals is less than Mth.

While in the previous description the frequency component power transforming unit 40 computes the square root of the rate of the powers \sqrt{PR/PK}, other ways of the arithmetic operation and/or other fixed attenuation factors (e.g., −6 dB/oct) may be used. Especially, when the computed result is greater than 1, an application of a certain attenuation to the reference frequency component is desired.

As has been described, in accordance with the embodiment of the present invention, the audio signal reproducing method of the first embodiment can be implemented in an arrangement of the audio signal reproducing device as shown in FIG. 2, so that even with audio signals coded with a low encoding bit rate which causes a difficulty in encoding high frequency components in the encoder, generation and extrapolation of the high frequency components enable such audio signals to be decoded and reproduced, having a desired amount of information. This is also useful in reducing an acoustic degradation of the reproduced signals in view of the human sense of hearing.

<Embodiment 3>

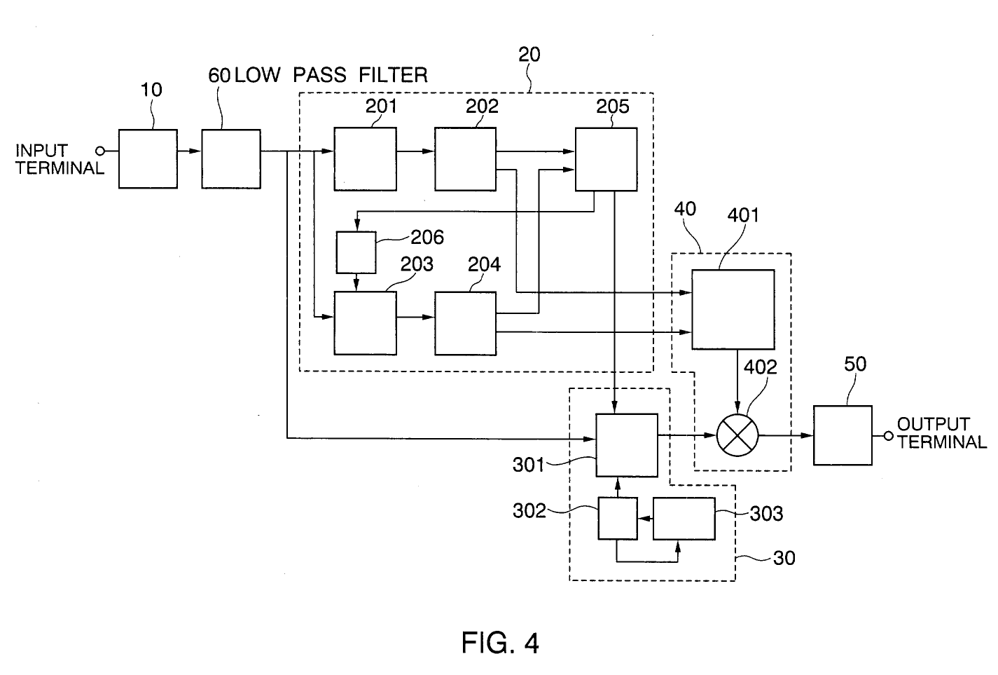

FIG. 4 is a block diagram showing another exemplary audio signal reproducing device or the third embodiment according to the present invention. This embodiment of the audio signal reproducing device has a low pass filter added in a previous stage to the frequency component domain seeking unit 20 in the second embodiment.

The audio signal reproducing device of the third embodiment is comprised of a frequency component decoder 10, a low pass filter 60, a frequency component domain seeking unit 20, a reference frequency component extracting unit 30, a frequency component power transforming unit 40, and an inverter 50. An initial value within the low pass filter 60 is zero. The frequency component domain seeking unit 20 has the reference frequency component extracting unit 30 and the frequency component power transforming unit 40 configured similar to those described in the second embodiment.

An operation of the audio signal reproducing device of the third embodiment will now be described. A stream of signals, when received at an input terminal, is decoded into frequency components by the frequency component decoder 10. The decoded stream is transmitted to the low pass filter 60 sequentially the frequency component of higher power first.

The low pass filter 60 eliminates high frequency components than a predetermined frequency range. Thus, since it removes fine fluctuations (noise components) which exist over frequency distribution, the distribution of frequency components will be made smooth.

Thus, the first frequency component extractor 201 extracts from the smoothened outputs of the low pass filter 60 N frequency components in a series starting with the first incoming non-zero frequency component (N is an integer). Assuming now that the first incoming non-zero frequency component is designated by x[M] (M is an integer, and M>N), the first frequency component extractor 201 extracts frequency components x[M−N+1] to x[M].

The second frequency component extractor 203 uses a value k on the first counter 206 (k is a first coefficient and is an integer) to extract N frequency components x[M−2N+1−k] to x[M−N−k] in series from a domain ranging from x[0] to x[M−N] different from those extracted by the first frequency component extractor 201.

Subsequently, similar to the aforementioned second embodiment, the extracted frequency components x are received at the first and second frequency component normalizers 202 and 204, respectively, which use the sums Pr and Pk of the frequency components to normalize those frequency components, respectively. The cross-correlation operation unit 205 computes a cross-correlation value C. On a second frequency component domain having the highest cross-correlation value to a first frequency component domain, the attenuation factor operation unit 401 of the frequency component power transforming unit 40 computes an attenuation factor. In the third embodiment, also, the reference frequency component may be damped with −6 dB/oct (at a fixed rate). Especially, a replacement with such a value is required when the rate of the powers is greater than 1.

The frequency component power transforming unit 40 carries out a multiplication of the reference frequency component extracted by the reference frequency component extracting unit 30 by the attenuation factor to produce a frequency component x[M+i] that is to be interpolated in a higher frequency band. After the frequency component that is to be interpolated is transmitted to the inverter 50 and is transformed into a time component, it is decoded. In this manner, the audio signals are reproduced, covering the high frequency band that does not exist in the stream.

In this way, according to this embodiment, since fine fluctuation of frequency distribution is eliminated by passing the audio signals decoded into frequency components, the frequency component domain seeking unit 20 can seek and retrieve the frequency component domains of better correlation matching.

Even with the audio signals coded at a low encoding bit rate that causes a difficulty in encoding the high frequency components in the encoder, generation and extrapolation of the high frequency components enable the audio signals to be decoded and reproduced, having a desired amount of information. This also is useful in reducing an acoustic degradation of the reproduced signals in view of the human sense of hearing.

<Embodiment 4>

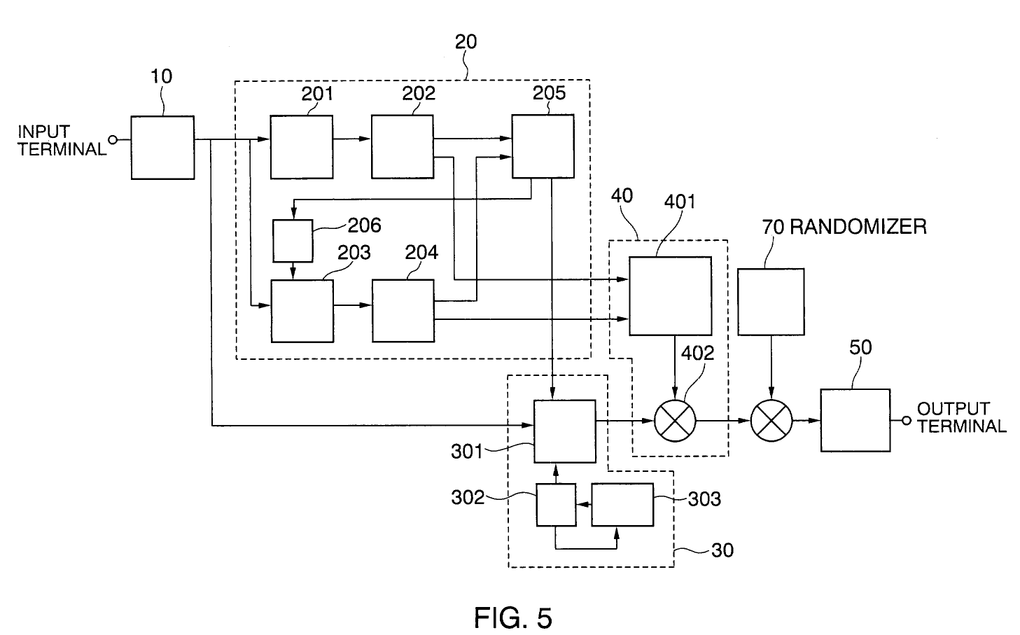

FIG. 5 is a block diagram showing still another exemplary audio signal reproducing device or a fourth embodiment according to the present invention. In this embodiment, in addition to the elements of the aforementioned second embodiment, the signal reproducing device includes a randomizer which carries out a multiplication of the reference frequency component by the attenuation factor obtained from the attenuation factor operation unit 401 to produce frequency components that are to be interpolated.

The audio signal reproducing device of the fourth embodiment is comprised of a frequency component decoder 10, a frequency component domain seeking unit 20, a reference frequency component extracting unit 30, a frequency component power transforming unit 40, an inverter 50, and a randomizer 70. The randomizer produces random numbers ranging from 0 to 1.

An operation of the audio signal reproducing device of the fourth embodiment will now be described. Process steps previous to attenuation of the reference frequency component are identical with those in the aforementioned second embodiment, and therefore, descriptions on them are omitted.

The multiplier 402 carries out a multiplication of the frequency component x[M−N−K+i] extracted in the reference frequency component extracting unit 30 by the value \sqrt{Pr/PK} obtained from the attenuation factor operation unit 401.

An output from the multiplier 402 or the frequency component \sqrt{Pr/PK}×x[M−N−K+i] is multiplied by the random numbers generated by the randomizer 70. The resultant products or the frequency components x[M+i], which are to be interpolated, are transmitted to the inverter 50. The inverter 50 transforms the frequency components into time components. Such frequency components that are to be interpolated are repetitively generated till the total of the generated components reach the maximum number Mth of interpolated components. In this manner, the audio signals are reproduced, covering the high frequency band that does not exist in the stream.

In this fourth embodiment, also, the frequency component \sqrt{Pr/PK}×x[M−N−K+i]) before the multiplication by the random numbers is transmitted to the reference frequency component extracting unit 30. This is used as the reference frequency component when the number of the interpolated components does not reach Mth.

Moreover, in the fourth embodiment, when a difference between the maximum and minimum values of the cross-correlation values computed in the cross-correlation operation unit 205 is greater than a threshold value Rth, the extrapolation of the frequency components in the high frequency band may be prohibited. With audio signals carrying dispersed frequency components as in simple tone or a combination of several simple tones, the extrapolation of frequency components in the high frequency band as mentioned before is prone to develop unnatural sound to the human sense of hearing. Such audio signals have a large difference between the maximum and minimum levels of the cross-correlation values, and thus, a comparison of the difference with the threshold value Rth permits discrimination from the unnatural sound. In this way, the undesired extrapolation of harmonic components can be avoided. In practice, the threshold value Rth may be 0.9, for example.

In this embodiment, random numbers, or namely, noise are used to produce frequency components that are to be interpolated, and hence, reproduced signals can develop tones very close to natural sound. Furthermore, even with audio signals coded at a low encoding bit rate that causes a difficulty in encoding the high frequency components in the encoder, generation of the high frequency components from the received audio signals and extrapolation of such frequency components in the decoder enable the audio signals to be decoded and reproduced, having a desired amount of information. In addition to that, this is also useful in reducing an acoustic degradation of the reproduced sound in view of the human sense of hearing.

In the fourth embodiment, also, a low pass filter may be added in a stage previous to the frequency component domain seeking unit 20 as in the aforementioned third embodiment. In this way, the similar effect to that of the third embodiment can be attained.

It is obvious that various modifications can be made without departing from the gist of the invention,

In accordance with the embodiments of the present invention, extrapolation of high frequency components in the decoder enables a reduction of an acoustic degradation even with a low encoding bit rate that usually causes a difficulty in encoding high frequency components. Also, bit allocation can be performed, significantly concentrated on middle to low frequency bands that contribute to the quality.

What is claimed is:

1. A method of reproducing audio signals comprising:
transforming audio signals into a plurality of frequency components;
seeking the plurality of the frequency components for a reference frequency component domain;
attenuating power of at least one of reference components in the reference frequency component domain to interpolate the frequency component in a frequency band higher than the reference frequency component domain, and
transforming the interpolated frequency component into a time component.

2. The method according to claim 1, wherein the seeking includes seeking the plurality of the frequency components for a second frequency component domain having the highest correlation in power spectrum to a first frequency component domain ranging a higher band, and defining a reference frequency component domain as a band that is higher than the second frequency component domain and also covers the first frequency component domain.

3. The method according to claim 2, wherein the interpolating includes attenuating power of the reference frequency component depending upon a value computed from the first and second frequency component domains.

4. The method according to claim 2, wherein the interpolating includes attenuating power of the reference frequency component at a fixed rate less than 1.

5. The method according to claim 3, wherein the interpolating includes attenuating power of the reference frequency component at a fixed rate less than 1 instead of the computed value when the value is greater than 1.

6. The method according to claim 2, wherein the interpolating includes interrupting the extrapolation of an additional frequency component when the number of the frequency components that have been interpolated is greater than the maximum number of the frequency components that are to be interpolated.

7. An apparatus of reproducing audio signals comprising:
a frequency component decoder configured to decode audio signals into frequency components;
a frequency component domain seeking unit configured to seek the frequency components for a reference frequency component domain that is to be interpolated in a high frequency band;
a reference frequency component extractor configured to extract a reference frequency component from the reference frequency component domain;
a frequency component power transforming unit configured to attenuate power of the reference frequency component for producing a frequency component that is to be interpolated, and
an inverter configured to transform the interpolated frequency component into a time component.

8. The apparatus according to claim 7, wherein the frequency component domain seeking unit includes:
a first frequency component extractor configured to extract a first frequency component domain ranging the highest frequency band;
a first normalizer configured to normalize the first frequency component domain;
a first counter configured to produce a first coefficient;
a second frequency component extractor configured to extract a second frequency component domain depending upon the first coefficient on the first counter;
a second normalizer configured to normalize the second frequency component domain, and
a cross-correlation operation unit configured to compute a correlation in power spectrum of the second, normalized frequency component domain to the first, normalized frequency component domain.

9. The apparatus according to claim 8, wherein the frequency component power transforming unit includes:
an attenuation factor operation unit configured to compute an attenuation factor from the first and second frequency component domains, and
a multiplier configured to multiply the attenuation factor by the reference frequency component.

10. The apparatus according to claim 8, wherein the reference frequency component extractor includes:
a second counter configured to produce a second coefficient, and
an extractor configured to extract the reference frequency component depending upon the second coefficient and the first coefficient at which the second frequency component having the highest correlation in power spectrum.

11. The apparatus according to claim 10, further comprising:
a comparator configured to compare the maximum number of the frequency components that are to be interpolated with the number of the frequency components that have been interpolated that is obtained from the second coefficient,
extrapolation of an additional frequency component being interrupted when the number of the frequency component that have been interpolated is greater than the maximum number of the frequency component that are to be interpolated.

12. The apparatus according to claim 7, further comprising a low pass filter configured to receive the frequency components from the frequency component decoder, to filter out any frequency component other than those ranging in a desired frequency band, and to transfer the remaining frequency components to the frequency component domain seeking unit.

13. The apparatus according to claim 7, further comprising:
a randomizer configured to generate random numbers ranging from 0 to 1, and
a multiplier configured to multiply the random numbers by the frequency component that is to be interpolated to transfer products to the inverter.
